(19) United States
(12) Patent Application Publication
(10) Pub. No.: US 2011/0169870 A1
(43) Pub. Date: Jul. 14, 2011

(54) Method and Device for Cancelling Deviation Voltage of a Source Driver of a Liquid Crystal Display

(76) Inventors: Jung-Ping Yang, Hsinchu County (TW); You-Kuang Chang, Nantou County (TW)

(21) Appl. No.: 12/860,929

(22) Filed: Aug. 22, 2010

(30) Foreign Application Priority Data
Jan. 14, 2010 (TW) 099100912

(51) Int. Cl. G09G 5/10; G09G 5/00

(52) U.S. Cl. 345/690; 345/212

(57) ABSTRACT

A method for cancelling the deviation voltage of a source driver of a LCD is disclosed. The method includes measuring an effective load resistor and an effective load capacitor of a panel of the LCD against the source driver, computing a lowest valid frequency of the chopper circuit according to the effective load resistor and the effective load capacitor, and adjusting the switching frequency of the chopper circuit according to the lowest valid frequency to filter out high frequency components of signals outputted by the source driver via the panel, so as to cancel the deviation voltage.

### BACKGROUND OF THE INVENTION

1. Field of the Invention

The present invention is related to a method and device for cancelling the deviation voltage of a source driver of a liquid crystal display (LCD), and more particularly, to a method and device that perform low-pass filtering on color signals which are suffered from the offset voltage of all operational amplifiers on driver IC. The panel of a liquid crystal display can be used as a low-pass filter.

2. Description of the Prior Art

A liquid crystal display (LCD) has characteristics of light weight, low power consumption, zero radiation, etc. and is widely used in many information technology (IT) products, such as laptop computers, mobile phones, and personal digital assistants (PDAs). The operating principle of the LCD is based on the fact that different twist states of liquid crystals result indifferent polarization and refraction effects on light passing through the liquid crystals. Thus, the liquid crystals can be used to control amount of light emitted from the LCD by arranging the liquid crystals in different twist states, so as to produce light outputs at various brightnesses, and diverse gray levels of red, green and blue light.

To arrange liquid crystals of each pixel of the LCD, the LCD normally includes a source driver for applying a control voltage on the pixel to control amount of light emitted from the pixel as well as a gray level thereof. Please refer to FIG. 1, which is a schematic diagram of a source driver 10 of the prior art. The source driver 10 is utilized for driving pixels belonging to a column of a panel 100 of the LCD, such as pixels P1, P2, . . . , PN shown in FIG. 1. The source driver 10 includes an input end 102, a first chopper 104, a gain stage amplifier 106, a second chopper 108, an output stage amplifier 110 and a low-pass filter 112. The input end 102 is utilized for receiving a color signal clr depending on desired image contents. The first chopper 104 is utilized for modulating the color signal to high frequency band by a first switch signal SW1 generated by an external control signal. The gain stage amplifier 106 is utilized for amplifying the color signal clr modulated by the first chopper 104 to generate an amplified color signal CLR. Similarly, the second chopper 108 is utilized for demodulating the modulated color signal and for modulating the offset voltage of the gain stage amplifier to high frequency by the second switch signal SW2. The output stage amplifier 110 is utilized for generating a source driving signal V_S according to the amplified color signal. Finally, the low-pass filter 112 performs low-pass filtering on the source driving signal V_S to cancel the modulated offset voltage of the source driving signal V_S induced by mismatch components of the gain stage amplifier.

In short, the source driver 10 sequentially drive the pixels P1, P2, . . . , PN based on scanning signals scan_1, scan_2, . . . , scan_N by a operational amplifier, chopper circuit 104 108 and a low-pass filter 112 to cancel the offset voltage induced by the mismatch components. However, to cancel the offset voltage of the driving signal V_s, large circuit area is required to implement the low-pass filter 112, which is obviously not economical.

Therefore, cancelling the offset voltage of the source driving signal more economically has been a major focus of the industry.

### SUMMARY OF THE INVENTION

It is therefore a primary objective of the claimed invention to provide a method and device for cancelling the deviation voltage of a source driver of a LCD.

The present invention discloses a method for cancelling the deviation voltage of a source driver of a liquid crystal display (LCD). The method comprises measuring an effective load resistor and an effective load capacitor of a panel and computing a lowest valid switching frequency of the chopper to filter out the offset voltage which is modulated to high frequency. The panel can be used as a low-pass filter to filter out the modulated offset voltage.

The present invention discloses a source driver for outputting a source driving signal to a panel of a liquid crystal display (LCD). The source driver comprises an input end for receiving a color signal, an output end coupled to the panel for outputting the source driving signal to the panel, a first chopper for modulating the color signal to high frequency band by the switch signal SW1, a gain stage amplifier for amplifying the modulated color signal outputted by the first chopper to generate an amplified color signal, a second chopper for demodulating the modulated color signal and for modulating the offset voltage induced by the mismatch components of the gain stage amplifier to high frequency band by the switch signal SW2. The output stage amplifier drives the demodulated color signal and the modulated offset voltage to the panel. The panel is used as a low-pass filter to filter output the modulated offset voltage induced by the mismatch components.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a source driver of the prior art.

FIG. 2 is a schematic diagram of a process according to an embodiment of the present invention.

FIG. 3A and FIG. 3B are schematic diagrams of effective circuits of a panel against a source driver when the source driver is connected to a pixel of the panel.

FIG. 4 is a schematic diagram of a source driver according to an embodiment of the present invention.

FIG. 5 is a time-domain waveform of the source driver shown in FIG. 4.

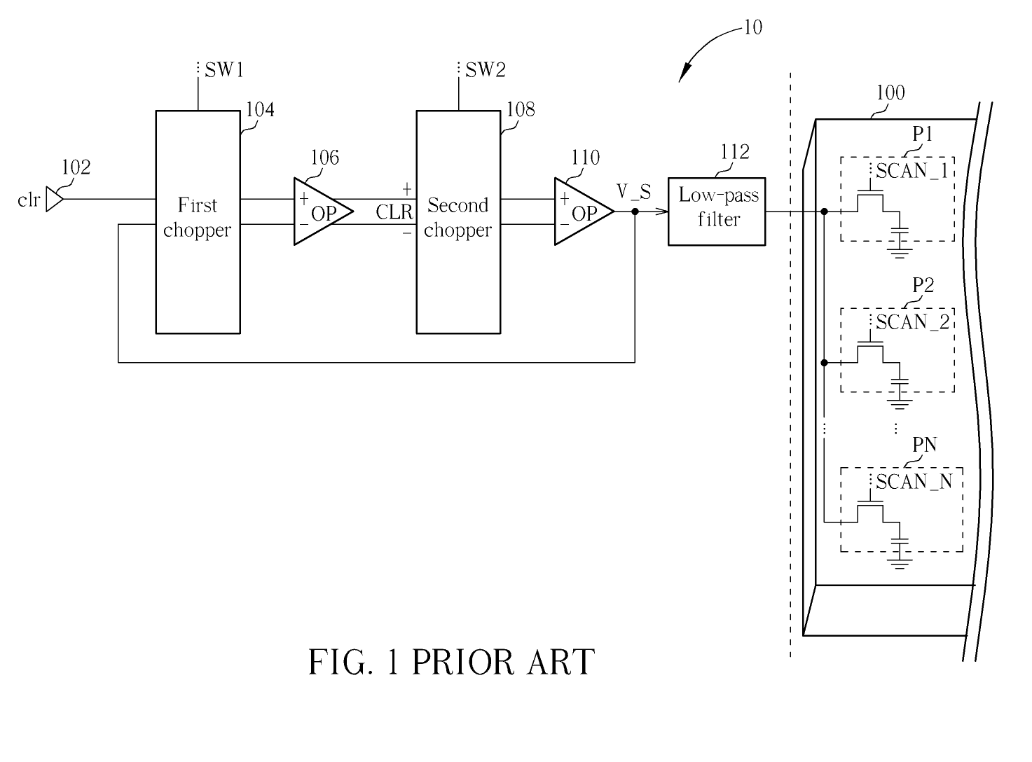

### DETAILED DESCRIPTION

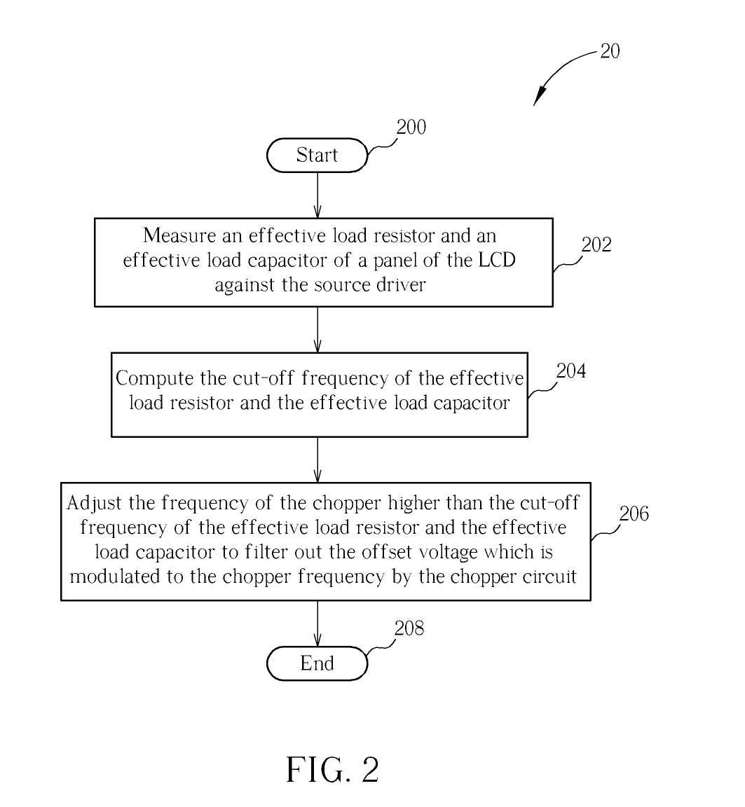

Please refer to FIG. 2, which is a schematic diagram of a process 20 according to an embodiment of the present invention. The process 20 is utilized for cancelling offset voltage of a source driving signal outputted by a source driver of a liquid crystal display (LCD). The process 20 includes the following steps:

Step 200: Start.

Step 202: Measure an effective load resistor and an effective load capacitor of a panel of the LCD against the source driver.

Step 204: Compute the cut-off frequency of the effective load resistor and the effective load capacitor.

Step 206: Adjust the switching frequency of the chopper higher than the cut-off frequency of the effective load resistor and the effective load capacitor to filter out the offset voltage which is modulated to the switching frequency of the chopper circuit.

Step 208: End.

Since an effective circuit of the panel can be regarded as a low-pass filter, once the effective load resistor and the effective load capacitor are measured, a cut-off frequency (the lowest valid frequency) of the low-pass filter made of the panel can be calculated. As a result, the switching frequency of the chopper can be adjusted based on the lowest valid frequency, so as to cancel the offset voltage via the panel.

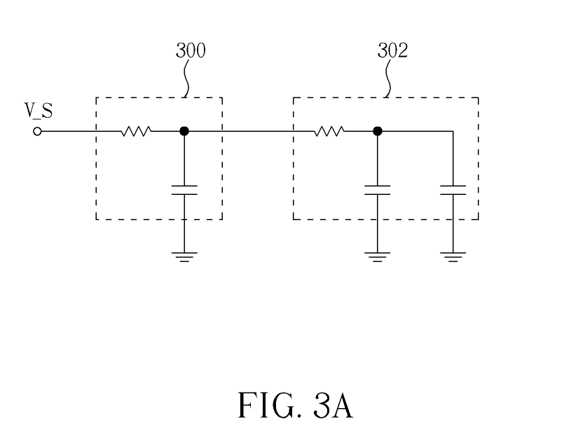

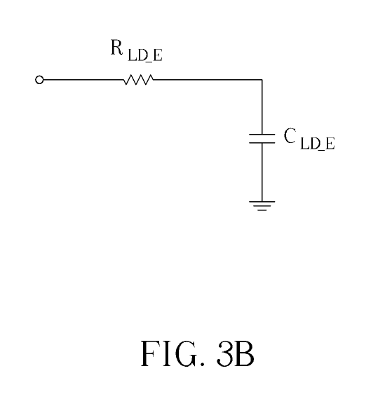

In detail, please refer to FIG. 3A, which is a schematic diagram of the effective circuit of the panel against the source driver when the source driver is connected to a pixel of the panel. According to circuit theory, a routing line load 300 and a pixel load 302 can be merged into an effective load resistor R_{LD}_{_{—}}_{E} and an effective load capacitor C_{LD}_{_{—}}_{E} as illustrated in FIG. 3B. Therefore, the cut-off frequency (the lowest valid frequency f_{LV}) of the low-pass filter shown in FIG. 3B can be represented as:

$${f}_{LV} = \frac{1}{2 π \times {R}_{LD \_ E} \times {C}_{LD \_ E}}$$

That is, with switching operations performed by the chopper, the source driver can adjust an oscillating frequency of the offset voltage to follow the switching frequency of the chopper. As a result, when the switching frequency is greater than the lowest valid frequency, the panel can remove high frequency components (greater than the cut-off frequency) of the offset voltage by performing low-pass filtering on the source driving signal. In other words, the switching frequency of the chopper has to be greater than or equal to the lowest valid frequency.

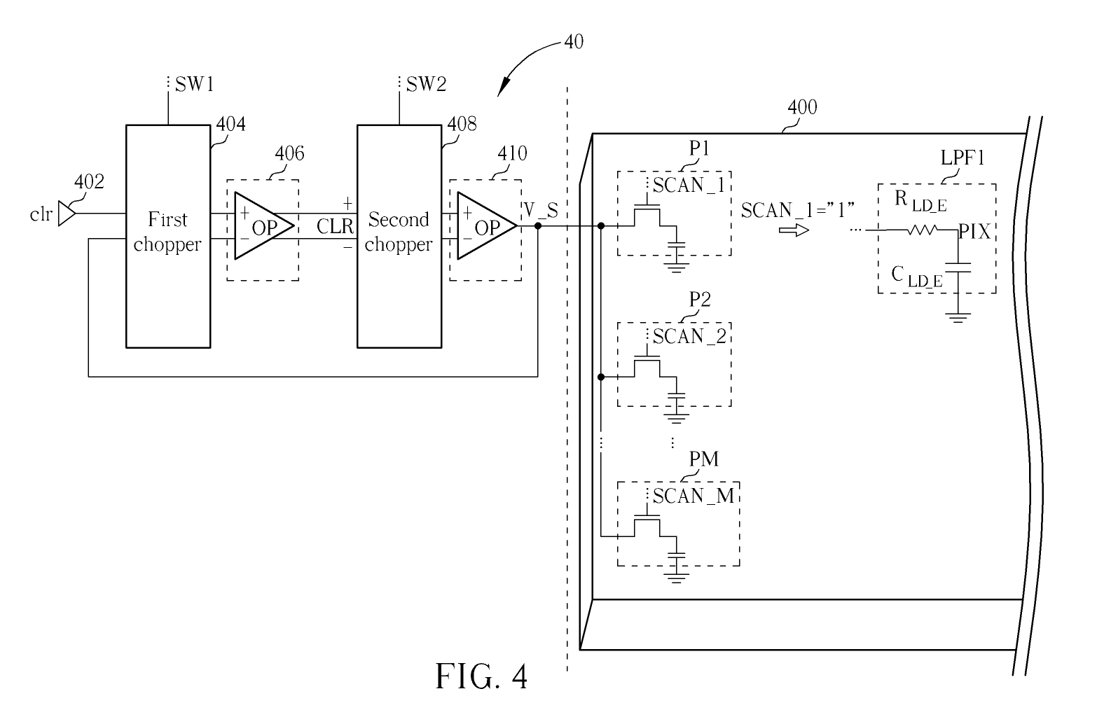

To implement the process 20, please refer to FIG. 4, which is a schematic diagram of a source driver 40 according to an embodiment of the present invention. The source driver 40 is utilized for outputting a source driving signal V_S to a panel 400 of an LCD to sequentially drive pixels P1, P2, . . . , PM belonging to a column of the panel 400 based on scanning signals scan_1, scan_2, . . . , scan_M. The source driver 40 includes an input end 402, a first chopper 404, a gain stage amplifier 406, a second chopper 408 and an output stage amplifier 410. The input end 402 is utilized for receiving a color signal clr depending on desired image contents. The first chopper 404 is utilized for modulating the color signal clr to the switching frequency of the chopper circuit by a first switch signal SW1 generated by an external control circuit. Next, the gain stage amplifier 406 amplifies the color signal clr modulated by the first chopper 404 to generate an amplified color signal CLR. Similarly, the second chopper 408 is utilized for demodulating the amplified modulated color signal CLR and for modulating the offset voltage which is induced by the component mismatch to the switching frequency of the chopper circuit by switch signal SW2. Finally, the output stage amplifier 410 generates and outputs the source driving signal V_S to the panel 400 according to the amplified color signal CLR.

In short, compared to the source driver 10 of the prior art, the source driver 40 enables the panel 400 to cancel the offset voltage of the source driving signal V_S by modulating the switching frequencies of the first chopper 404 and the second chopper 408. Thus, the low-pass filter 112 is no longer required in the source driver 40, implying the source driver 40 can achieve a smaller circuit layout area and a more economical cost.

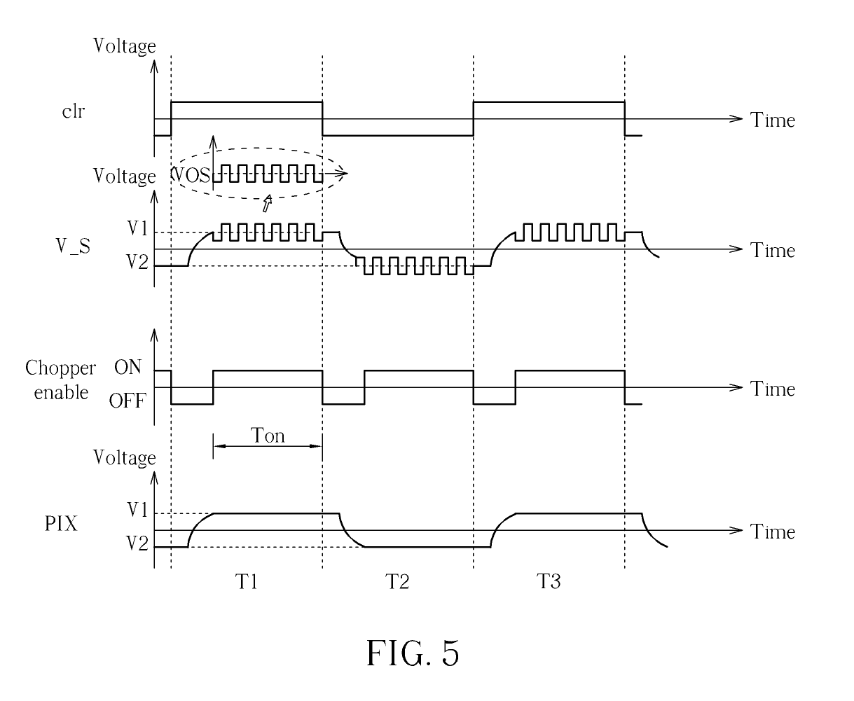

In detail, please refer to FIG. 5, which is a time-domain waveform of internal signals of the source driver 40. In FIG. 5, periods T1, T2, T3, etc. respectively represent time intervals in which the source driving signal V_S drives the pixels P1, P2, P3, etc., respectively. Due to non-ideal factors like mismatched components, the offset voltage (VOS) exists in the source driving voltage V_S, resulting in the source driving voltage V_S oscillating around ideal output voltages V1, V2. However, for the source driver 40, the panel 400 can be regarded as a low-pass filter LPF1 when the source driver 40 is connected to any pixel of the panel 400, as illustrated in FIG. 4. As a result, with low-pass filtering performed by the panel 400, the offset voltage can be removed from the source driving voltage V_S, such that a voltage difference PIX between two ends of the pixel can approach the ideal voltage levels V1, V2, as illustrated in FIG. 5.

Details of the source driver 40, such as limitations of the switching frequencies of the chopper 404, 408 can be referred from the description of the process 20, and are not further narrated herein. In addition, preferably, the first chopper 404 and the second chopper 408 are not necessary to be enabled all the time. That is, the first chopper 404 and the second chopper 408 can operate only when source driving signal V_S settles to some certain level as illustrated in FIG. 5, the enable time of the chopper Tₒₙ can be varied to save the power consumption of the circuit. Certainly, those skilled in the art can implement various control methods to meet specific requirements. For example, the first chopper 404 and the second chopper 408 can also operate full-time without turning on and off during T1, T2, T3, . . . etc.

In the prior art, the source driver 10 cancels the offset voltage of the source driving signal V_S through the low-pass filter 112. Thus, large circuit area is required to implement the low-pass filter 112. In comparison, the present invention adjusts the switching frequencies of the choppers 404, 408, such that the oscillating frequency of the offset voltage can be filtered out on the panel. In such a situation, as long as the switching frequencies of the choppers 404, 408 are adjusted to be greater than the cut-off frequency (the lowest valid frequency) of the panel 400, the offset voltage can be removed from the source driving signal V_S, and therefore production costs of the low-pass filter 112 can be saved.

To sum up, the present invention treats the panel of the LCD as a low-pass filter. With corresponding frequency modulation operations, the panel can replace the traditional low-pass filter installed in the source driver to reduce the production costs of the source driver.

Those skilled in the art will readily observe that numerous modifications and alterations of the device and method may be made while retaining the teachings of the invention.

What is claimed is:

1. A method for cancelling a deviation voltage of a source driver of a liquid crystal display (LCD), the source driver comprising a chopper circuit, the method comprising:
measuring an effective load resistor and an effective load capacitor of a panel of the LCD against the source driver;
computing a lowest valid frequency of the effective load resistor and the effective load capacitor; and
adjusting a switching frequency of the chopper circuit according to the lowest valid frequency to filter out high frequency components of signals outputted by the source driver for cancelling the deviation voltage.

2. The method of claim 1, wherein the lowest valid frequency is equal to
$${f}_{LV} = \frac{1}{2 π \times {R}_{LD \_ E} \times {C}_{LD \_ E}} ;$$
wherein R_{LD}_{_{—}}_{E} represents the effective load resistor and C_{LD}_{_{—}}_{E} represents the effective load capacitor.

3. The method of claim 1, wherein the step of adjusting the switching frequency of the chopper circuit according to the lowest valid frequency comprises adjusting the switching frequency to be greater than or equal to the lowest valid frequency.

4. A source driver for outputting a source driving signal to a panel of a liquid crystal display (LCD), the source driver comprising:
an input end, for receiving a color signal;
an output end, coupled to the panel, for outputting the source driving signal to the panel;
a first chopper, for modulating the color signal received by the input end according to a first switch signal;
a gain stage amplifier, for amplifying the color signal outputted by the first chopper to generate an amplified color signal;
a second chopper, for demodulating the amplified color signal and for modulating an offset voltage of the source driving signal according to a second switch signal; and
an output stage amplifier connected to the panel, for generating the source driving signal according to the amplified color signal.

5. The source driver of claim 4, wherein switching frequencies of the first switch signal and the second switch signal are greater than or equal to a lowest valid frequency.

6. The source driver of claim 5, wherein the lowest valid frequency is equal to
$${f}_{LV} = \frac{1}{2 π \times {R}_{LD \_ E} \times {C}_{LD \_ E}} ;$$
wherein R_{LD}_{_{—}}_{E} represents an effective load resistor of the LCD and C_{LD}_{_{—}}_{E} represents an effective load capacitor of the LCD.

7. The source driver of claim 4, wherein the panel acts as a low-pass filter filtering out the modulated offset voltage of the source driving signal.

8. The source driver of claim 4, wherein the first chopper and the second chopper are enabled to perform switching operations only when an enable signal is turned on.
